(19) United States
(12) Patent Application Publication
(10) Pub. No.: US 2011/0159956 A1
(43) Pub. Date: Jun. 30, 2011

(54) ENTERTAINMENT TERMINAL WITH IMPROVED USER INTERFACE

(76) Inventors: Boris Itskov, Concord (CA); Elena Zhukova, Concord (CA); Valery Levitan, Concord (CA)

(21) Appl. No.: 12/998,013

(22) PCT Filed: Sep. 9, 2009
(86) PCT No.: PCT/CA2009/001231

§ 371 Date: Mar. 9, 2011

(30) Foreign Application Priority Data
Sep. 9, 2008 (CA) 2639452

(51) Int. Cl. A63F 13/00

(52) U.S. Cl. 463/31

(57) ABSTRACT

An entertainment terminal has an improved user interface presenting an effective more consistent interface for selection of particular games, music, video or other material for play. In particular the interface is adapted to provide better consistency whereby knowledge or experience in game selection or other categories simplifies selection in a different category.

### FIELD OF THE INVENTION

The present invention relates to entertainment terminals, and in particular, entertainment terminals for commercial establishments having an improved method and interface for selecting of different entertainment products to be played.

### BACKGROUND OF THE INVENTION

As with many technologies, entertainment terminals for commercial establishments have combined a number of different capabilities into a single terminal. In particular, digital jukebox capabilities have been combined with game terminal capabilities in a single terminal.

Game terminals for commercial establishments such as restaurants and bars originally may have had 10 to 15 games that were playable on the terminal. In recent years, improved performance and cost efficiencies have allowed terminals to include over 100 different games. Digital jukeboxes have always faced the difficulty of providing an acceptable user interface allowing a user to quickly access a particular song for play based on perhaps limited information available to the user as well as requiring a large storage capability.

A countertop terminal suitable in a bar or a restaurant application can advantageously combine the capabilities of both a game terminal and a digital jukebox capable of allowing music to be selected for play. One of the significant challenges is to provide a method and an interface that allows a user to quickly navigate the various choices by using predetermined categories while presenting the information in such a way whereby subsequent selection steps are easily understood or quickly discovered.

In earlier game terminals it was known to present to the user a particular game option provided on the screen in combination with other games that could be selected provided on a list to one side. As the number of games on the terminal increased, a scroll button was provided to allow the user to scroll through the various options. As the number of games that were possible to play on the device increased, this type of system was not effective. Categories were introduced which further occupied space on the screen, but did allow the player to choose a different category in an attempt to arrive at a particular game for selection. Basically, pressing of a category button took the player to yet a different menu and although this system has some advantages, it was common for players to get confused with respect to the searching model.

In our currently offered iTouch system, a few categories and some games in a selected category are all provided on the screen at the same time. This system is more effective, but a player still needs to scroll through categories and flip through short lists of games in the selected category in an attempt to provide a particular selection. The system is more effective, but still requires some expertise to navigate. Furthermore, other, much broader options, such as the ability to select a tournament option or the ability to select a particular music option, requires the player to return to an upper level, rendering it less than optimized.

It has been known to provide a series of related menus with each menu being appropriately displayed on the screen when selected. This type of approach, even with some interaction on a menu, has not provided an effective presentation of the information to allow a user to quickly research a particular type of selection and quickly reverse the steps if required. The ability to present this information in an effective manner that is convenient to the user is extremely important, as it significantly impacts sales and the experience in using the combined entertainment terminal. These types of terminals all include a pay-to-play arrangement based on credit cards, banknote validators or other payment arrangements that are built into the terminals.

### SUMMARY OF THE INVENTION

An entertainment terminal according to the present invention comprises a computer processor, an operating system, a display screen, a user input arrangement, and computer memory. The terminal includes, in the computer memory, a host of games for play using the terminal. The terminal further includes a user interface displaying on said display screen a subset of the host of games together with user selectable categories. The subset is determined according to a selected or default category displayed on the screen with the subset. The displayed subset allows a player to review and select a particular game to be played from the subset of games displayed. The user interface displays at least a substantial portion of the subset as an adjustable sequence of games extending generally across the display screen with one of the sequence of games, according to predetermined criteria, being selectable by a user for play and displayed in increased detail and size. The user interface responds to user input to adjust the sequence whereby any of the sequence of games can be selected by adjustment of said sequence to cause a desired game to be displayed in said increased detail and size. The user interface displays, on the display screen, the categories in an area separate and distinct from the subset. The user interface, upon actuation of one of the categories, alters the sequence of games displayed to correspond with the category.

According to an aspect of the invention, the terminal displays the selectable game in a central area of the display screen.

In a further aspect of the invention, the terminal displays a selectable game to partially obscure and overlay adjacent games in the sequence.

In a further aspect of the invention, the sequence of games includes a graphic representation of each game of the sequence other than the selectable game, only having a portion of the graphic representation displayed and the selectable game having the complete graphic representation displayed.

In a further aspect of the invention, the sequence of games are displayed as a three-dimensional image with the selectable game being most forward in the image and the sequence of games either side of the selectable game progressively being more rearward as the separation from the selectable game increases.

In a further aspect of the invention, the categories include graphic representations less than 50% of the size of the graphic representations of the games of the sequence immediately either side of the selectable game and positioned as a sequence adjacent a lower edge portion of the display screen.

In yet a further aspect of the invention, the categories are displayed on the display screen with the sequence of games with the illusion each are supported on a horizontal surface with the categories positioned in the foreground.

In yet a further aspect of the invention, the interface displays at a bottom horizontal edge of the display screen a strip region of general controls used to clarify operation of the terminal. The display of the general controls does not form part of the horizontal surface, including the category controls and the sequence of games.

In a further aspect of the invention, the terminal additionally includes a host of music records that can be selected for play using the terminal. The memory includes graphic images of at least albums associated with the music records and titles thereof. The user interface provides a user selectable control for selecting between games and music records. The user interface illustrates an album category of the music records in the same manner as a subset of said games allowing the user to select a particular album. The interface, when a particular album is selected, provides a larger image in replacement of the selectable album image with the larger image providing details of the music records of the album that can be selected for play.

In yet a further aspect of the invention, the interface provides details of the music records, the games and the categories on a common three-dimensional representation of a horizontal surface extending into the display screen.

In a further aspect of the invention, the display screen is a touch screen and the sequence of games and sequence of music albums are responsive to a touch input sweeping across the sequence to vary the sequence selection process.

### BRIEF DESCRIPTION OF THE DRAWINGS

Preferred embodiments of the invention are shown in the drawings, wherein:

FIG. 1 is a perspective view of the game terminal with the improved user interface;

FIG. 2 is a screen shot of the display screen with the user interface with a first user selection indicating “Games” and a particular game category “New Games” being displayed;

FIG. 3 is a view of the display terminal similar to FIG. 2 where a user has caused the sequence to advance towards the right edge several games and now displays the selectable game “Poseidon Adventure”;

FIG. 4 is a depiction of the display screen with music being selected and a sequence of albums being displayed;

FIG. 5 is a view similar to FIG. 4 showing a sequence of albums with the details of one particular album, “My Blueberry Nights” being shown in increased detail with the actual song records;

FIG. 6 is a screened shot, again with respect to music, with the subcategory by song being used and various songs being shown in a three-dimensional selectable manner similar to the pages of song records used with original jukeboxes. Basically, these can be selected much like pages in a book merely by sweep rotation across the structure to allow adjustment thereof;

FIG. 7 is a screen shot of the display screen when a particular game is being played; and

FIGS. 8 through 17 are screen shots of additional features.

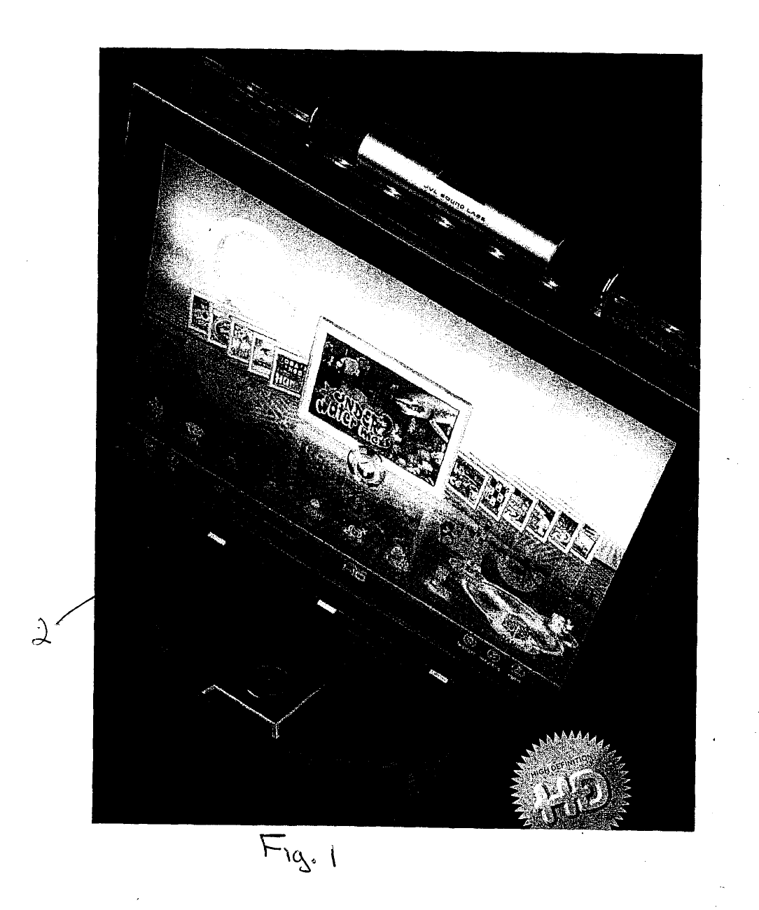

### DETAILED DESCRIPTION OF THE PREFERRED EMBODIMENTS

The entertainment terminal 2 includes a combination touch screen display screen 4 and a user interface panel 6 adjacent the base of the screen. The user interface panel is produced on the touch screen and remains during the selection process. The terminal includes a payment slot 8 and a series of speakers provided about the unit. Internal to the terminal 2 is a computer processor, a computer memory and operating software including the particular user interface used to generate the various screen shots.

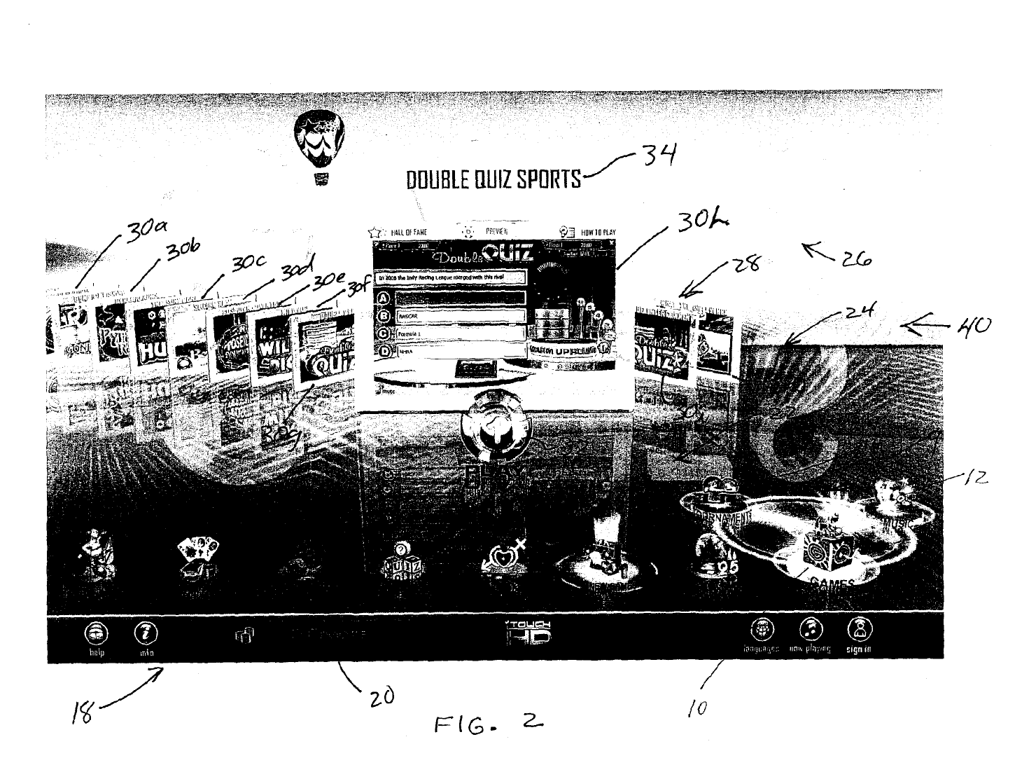

This particular entertainment terminal is a multi-purpose terminal allowing a user to select from, in this embodiment, the rotatable carousel 9 having three different entertainment categories, namely “Games” indicated as 10, “Music Selection” indicated as 12, and “Tournaments” indicated as 14. In the embodiment shown in FIG. 2 and the related screen shots, the entertainment category most forward on the rotatable carousel 9 is the particular one that is selected. If a user wishes to switch from the most forward entertainment category to one of the other two categories, in this case either “Music” or “Tournaments”, the player touches the particular graphic image and the carousel will rotate to position the selected entertainment category in the most forward position.

After the player has selected “Games”, “Music”, or “Tournaments”, the further categories for that particular selection are displayed to the left of the rotatable carousel 9 in a region that is generally indicated as 16. Region 16 includes the sequence of categories provided across the base of the screen shot indicated as “Sports Action”, “Cards”, “Puzzles and Strategy”, “Word and Quiz”, “Erotic”, “New Games”, and “Top Games”. There is also shown on the display screen a further band at the base of the screen indicated as 18 which depicts a number of fixed controls. These fixed controls shown at 18 include the particular icons “Help”, “Info”, “Languages”, “Now Playing” and “Sign In”. There is also a region to indicate the number of credits available, indicated as 20. These fixed controls are provided on each of the screens for use selection input, and when activated, provide information with respect to the particular selection or clarification regarding use of the terminal.

With respect to games, this terminal includes over 140 games and the games are divided into the particular categories. Some games may be included in more than one category, but these categories are predefined to allow the user to quickly have the most appropriate games presented to him and to provide the information quickly. The screen shot of FIG. 2 is based on the illustration of an extensive horizontal surface indicated as 22 with the particular game categories indicated as 16 provided adjacent a front edge of this horizontal surface. The display screen, in addition to the horizontal surface, includes an illustrated horizon 24 and a sky portion 26 to provide an improved depth perception of the horizontal surface 22.

The user interface, when games are selected for example, assumes a particular sub-category indicated as a highlighted or distinguished icon of the subcategories 16. This allows the game interface to present a subset of the sequence of the games indicated as 28 with this sequence displayed on the horizontal surface 22 near a rear edge of the horizontal surface. The sequence extends across the page, and is supported to extend above the horizontal surface. The individual games of this sequence are shown as 30a through 30j. The particular game 30h is shown in the centre portion and is of increased size relative to the other games. Each of these games includes a graphic image to allow more ready association with the particular game. Only a portion of the graphic image is provided within the sequence unless the game is one that could be selected as indicated as 30h. A user can run his finger across the sequence (drag) and cause adjustment of the sequence whereby the particular game that can be selected changes. As noted in FIG. 2, the graphic depiction of the game “Double Quiz” 30h is provided in the centre portion and allows a user to review additional information if he wishes to proceed. With this arrangement, the selected game 30h includes good detail to allow the selection thereof with the other games of the sequence providing less information, but sufficient information for general recognition. This arrangement reduces confusion due to excessive information being presented.

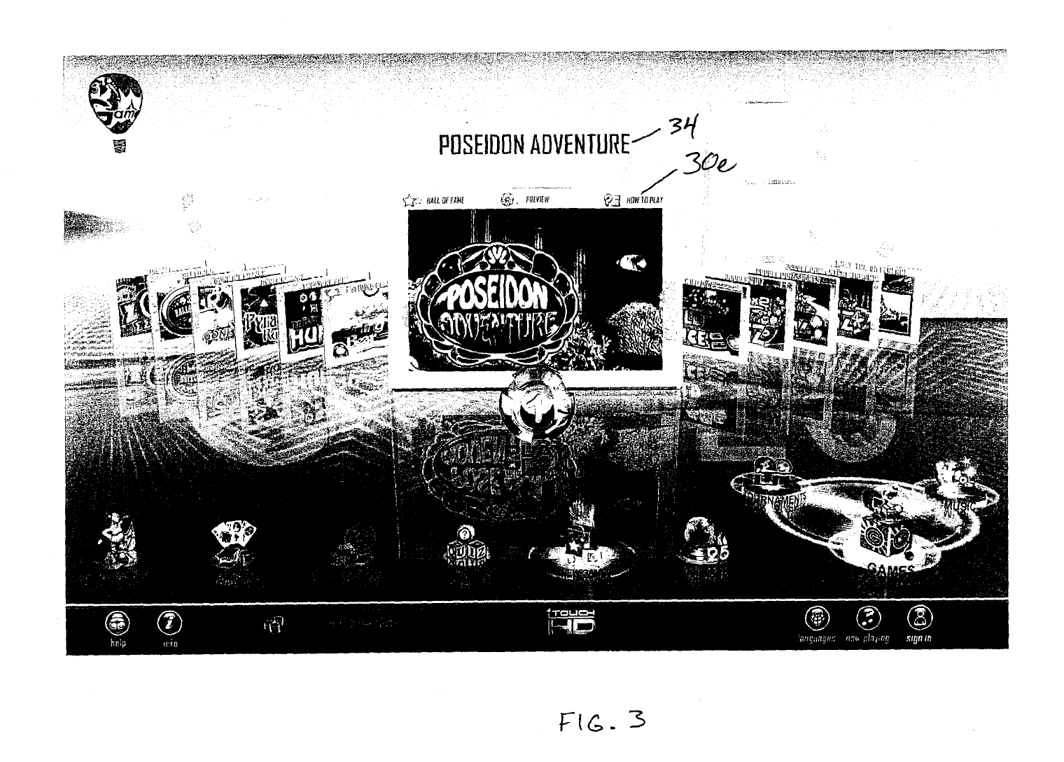

The screen shot of FIG. 3 is similar to FIG. 2, although the user has dragged his finger from the left towards the right to cause the game “Poseidon Adventure” to be shown in enlarged format. This is game 30e in FIG. 2. A player can indicate that he wishes to play the selectable game shown in the enlarged format merely by touching the “Play” image indicated as 32. Note with the displays of FIGS. 2 and 3, the particular game that can be selected has its graphic image provided in the centre portion of the screen in an enlarged format with a size more than double the size of the other games of the sequence, and additionally the game title is provided above the selectable game at position 34. This provides additional clarification of the game that could be selected. Also the selectable game is not at the angled orientation of the other games on the horizontal surface.

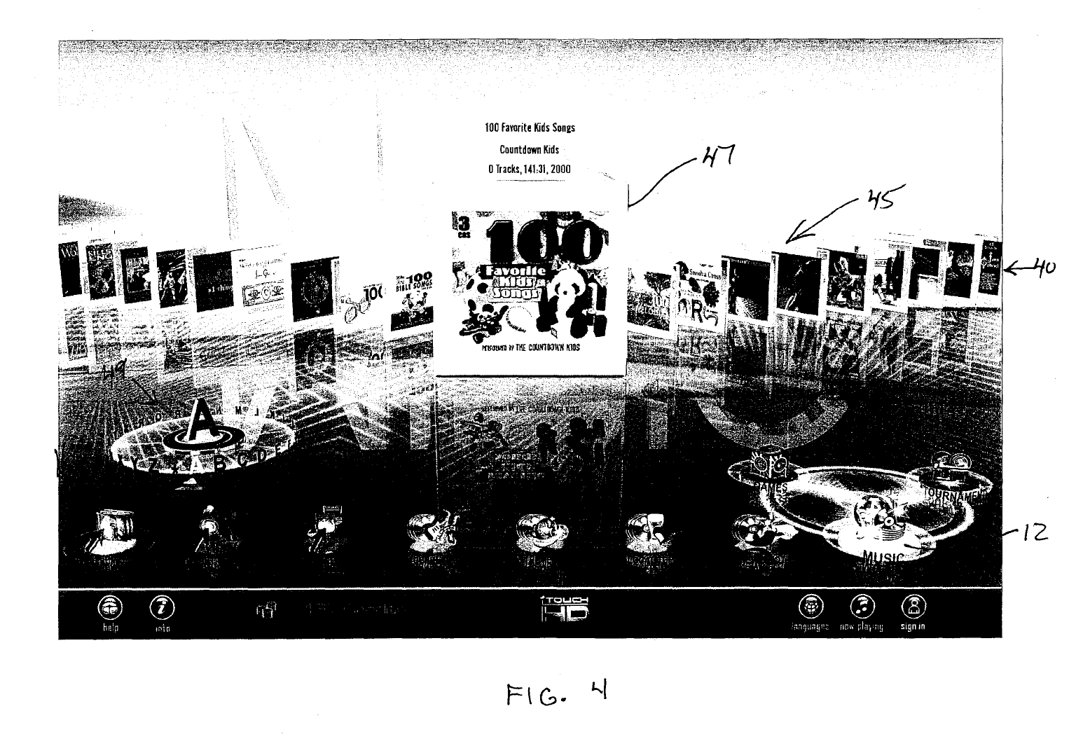

If the player does not wish to proceed with those particular games, he can touch a different category to have a different sequence of games provided at this mid-portion of the display screen generally indicated as 40. In this way, the user can quickly reverse the strategy and/or alter the particular selection. For example, the player may wish to consider ordering a music record and the user can merely touch the music graphic 12 indicated in FIG. 2 or 3 and this would cause the display screen to be reconfigured as generally indicated in FIG. 4. In this case, you can see that the music graphic indicated as 12 has now moved towards the forefront of the rotatable carousel 9 and new categories are provided at the band region 16. These new categories are appropriate for music and include the categories “By Album”, “By Artist”, “By Song”, “Genres”, “Theme”, “Local Top”, and “New Hot”. The display screen of FIG. 4 includes a sequence of music records shown as individual graphic images with the sequence generally shown as 45. The sequence extends across the display screen at the same location generally indicated as 40. One particular song record, in this case the song album “100 Favorite Kids' Songs” is selectable at the centre of the screen as generally indicated by 47.

Within the music category, a rotatable alphabetic carousel indicated as 49 is provided in the foreground of the horizontal surface 22 to provide a further simple arrangement for the user to vary the particular song records or song albums being displayed. This alphabetic index can work with any of the categories indicated as 16. Touching of the carousel allows adjustment of the particular alphabetic letter that will be displayed and used to sort the displayed music records.

With the music as indicated by album in FIG. 4, the album does not display the actual music records, but merely a further sub-category that allows the user to further define his selection. By touching the particular selectable album indicated as 47 in the centre of the displayed horizontal surface, details of the particular album will be displayed as shown in FIG. 5. The selected album 49 is shown in a larger depiction area 61, but again centrally with the particular album being indicated at 51 as well as the title being indicated at 53. The individual records are shown at 55 with these individual records being selectable by the user. Slide bar 57 allows the user to move within the particular music records of the particular selected album. This can also be completed by dragging as opposed to slide bars. In addition, more albums by this artist are also provided in the image shown at 59 with a further slide bar 63 for varying the albums. Thus, if a user changes his mind, he can return to the sequence of music albums merely by touching the sequence of music albums or he could rearrange his thoughts with respect to music by selecting one of the different categories provided at 16.

This arrangement allows the user access to a number of different selections to allow him to quickly move within the music records to locate a particular record that he wishes to play. There is no requirement to step through a host of menus that are individually provided, as the various menus or categories used to divide the songs are provided on the screen, and as such, allows him to easily move throughout the records. Similarly, he can jump between “Games”, “Music” or “Tournaments” merely by changing the carousel indicated as 11.

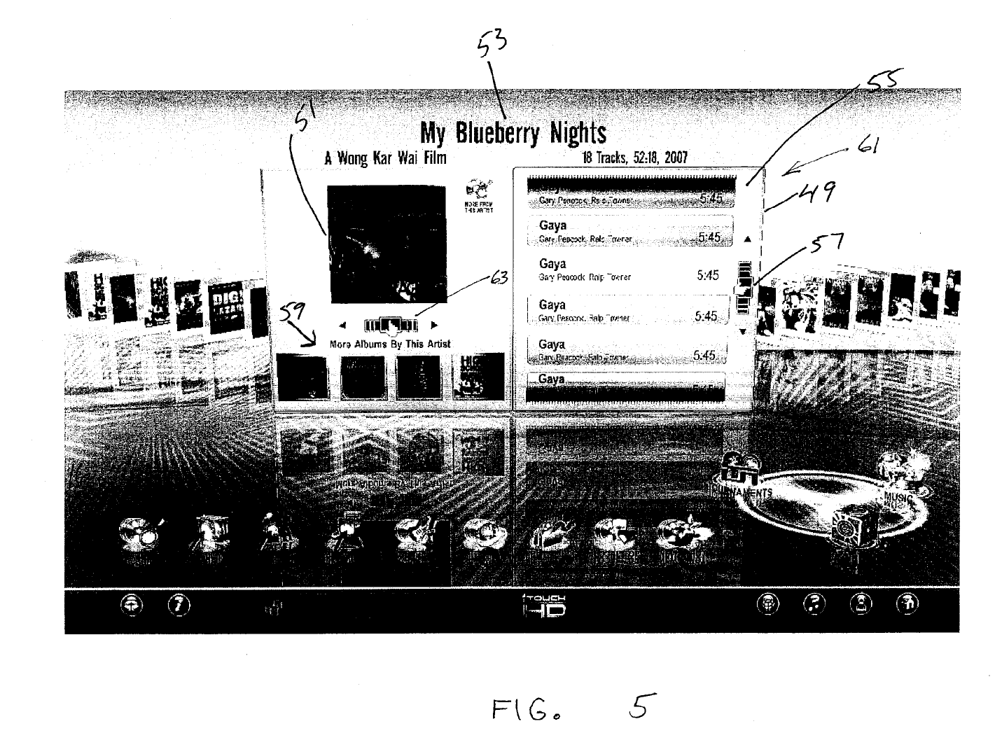

A slightly different arrangement is shown in FIG. 6 where the music category has been selected, and the person has indicated that he wishes to review the individual music records by a different category within the category 16. In this case, the display at the centre is again a three-dimensional horizontal surface display indicated as 60 of particular music records that are illustrated as individual pages of a book or series of panels indicated as 65. The user touches/sweeps across these pages to cause the turning thereof and he can review the particular list of music records, any of which can be selected.

This provides a three-dimensional representation that might be considered equivalent to the original jukeboxes having user-adjustable listings of pages that were effectively turned about a centre axis. This type of presentation is readily understood by the user and is easily adjusted. The advantages of the large three-dimensional display, that allows for effective selection of a particular record in combination with the categories that allow adjustment of this three-dimensional selectable area, allows a user to move between the different categories and selections to achieve a desired selection in an intuitive manner. The presentation of “Music”, “Games” and “Tournaments” in a similar manner and on a similar three-dimensional surface with the selection being in a central portion of the display screen, typically in the upper half of the display screen, with categories and adjustments provided on this surface in the foreground, also provides an effective communication of information in a consistent manner.

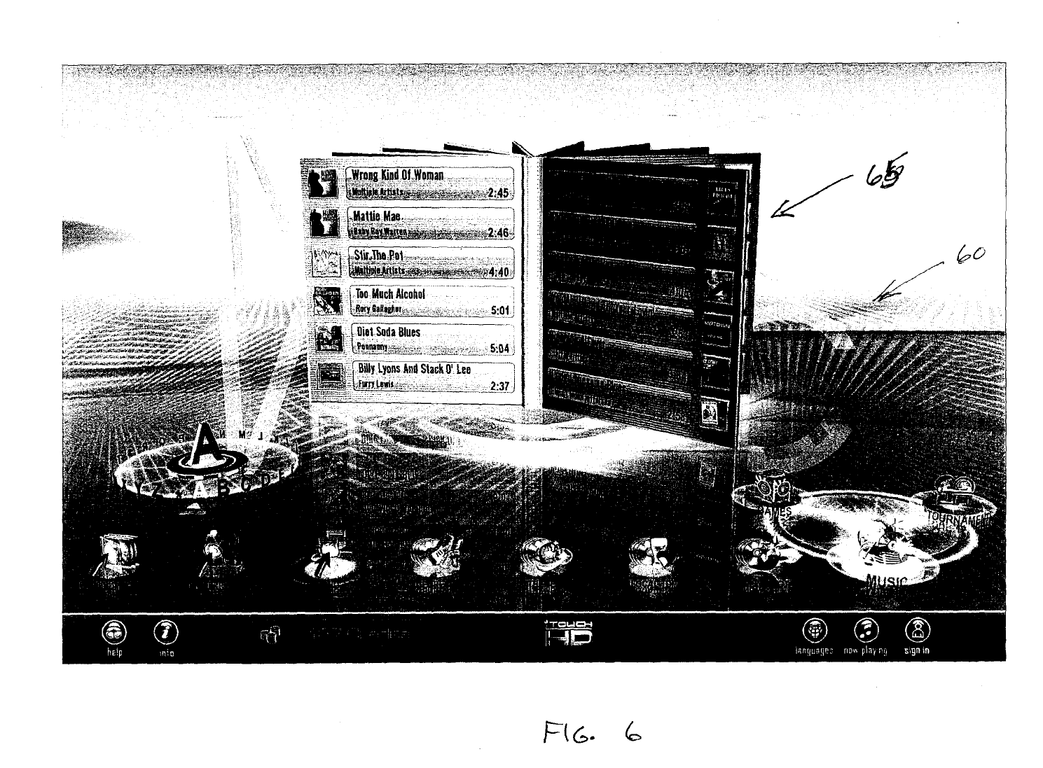

The display screen of FIG. 7 illustrates the terminal's use of the entire display screen for playing of the particular game “Double Quiz”. This can certainly be adjusted for additional space on the screen for banner-type advertising or header-type or baseline advertising, but a large portion of the display screen is used for playing of the game. Preferably the size of the advertising banner is scalable allowing the portion of the screen for game play to be varied. The banner advertising may only be present during the selection process.

It has been found that this particular user interface and the standardized presentation of different options associated with distinctly different-type products of games and music allows for a fast learning curve and a user-friendly system for selecting and playing of different entertainment products.

It can be readily appreciated that should a different option become available to the entertainment terminal, for example broadcast options, the broadcast option may be provided on the carousel, and the user can select the broadcast option with a similar presentation of this information in the equivalent three-dimensional horizontal surface used with respect to the other categories. Thus, the user interface is readily expandable to accept additional capabilities of the terminal as they become available. Thus, the system allows ready expansion while maintaining the method of selection used by the player to quickly select a desired product.

A further advantage of the present system is in that the display screen, prior to an actual selection of an entertainment product and the playing thereof, allows the user to explore the various products that are available and quickly review sub-categories and the presentation of additional products that can be selected.

With the present system, a player is able to quickly identify a game he has already played, or is able to find a game that he might be interested in playing, in a time-efficient manner. The system provides more visual information to the player while browsing through available game options. The design allows the presentation of visual information to the player of the various available game options. The design allows the presentation of visual information to the player of the various options, and has reduced the size with respect to a particular selection until that selection has been further identified by the user as a desired choice. In this way, additional information regarding related choices and the ability to quickly scroll through these is possible. In addition, other tools have been provided on the screen, such as the alphabetic carousel, where if the user knows a particular name of the game, he merely uses the carousel and is quickly taken to games having that particular starting letter. As further discussed above, this type of approach is used for games and for music, and thus if the patron is familiar with the selection associated with games or music, he can quickly use these skills in the related categories.

The present user interface uses a 3-D environment with the depth of view and intuitive transitions with dynamic visual effects. This provides the player with the feeling that all menu choices are present on the 3-D menu, and the relative importance of the various choices is available to him. For example, the choices that were initially made are at the foreground of the screen, whereas his more recent choices are provided further in the screen. The ability to return to the upper levels or any of the subsequent levels is also conveniently provided. The switching from one category to another changes the possible selections, but maintains the overall appearance. This renders the system less confusing and more intuitive. These aspects are particularly important, as the game terminal is effectively a self serve-type device, and the user quickly identifying a particular game or music record or tournament of interest to him increases the likelihood of the patron paying for this particular selection. Furthermore, the system quickly adapts to further increases in the particular games and musical selections and other options that will continue to expand. This can easily be recognized from the transition over the last ten years from game terminals having a very limited number of games to game terminals having a host of selections available.

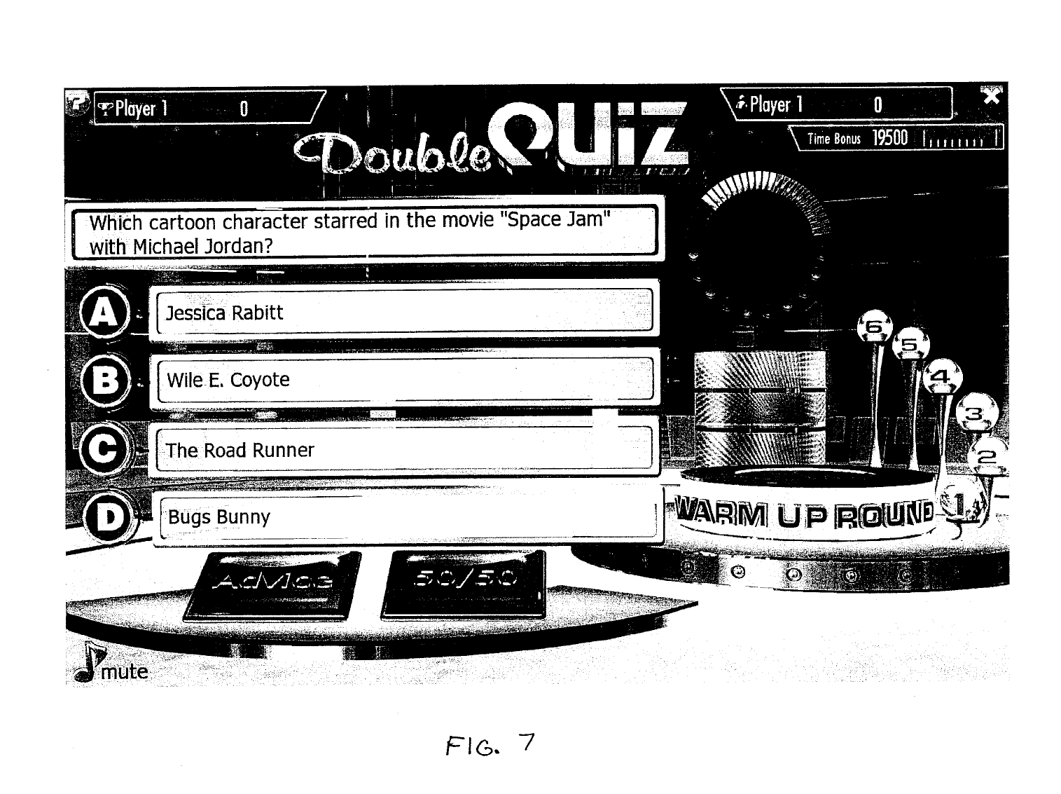

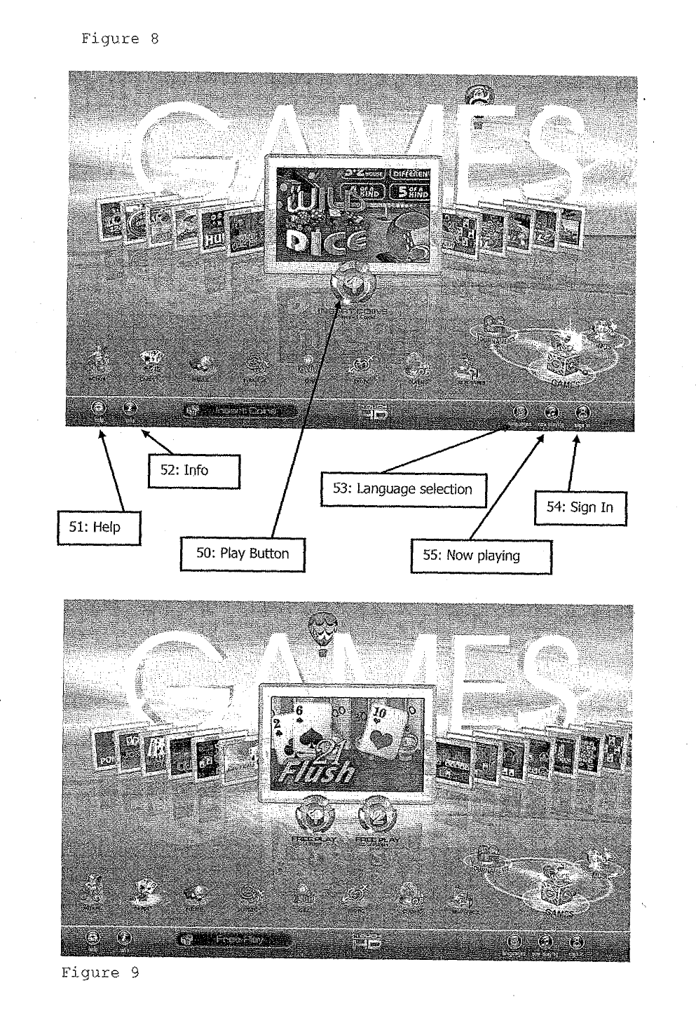

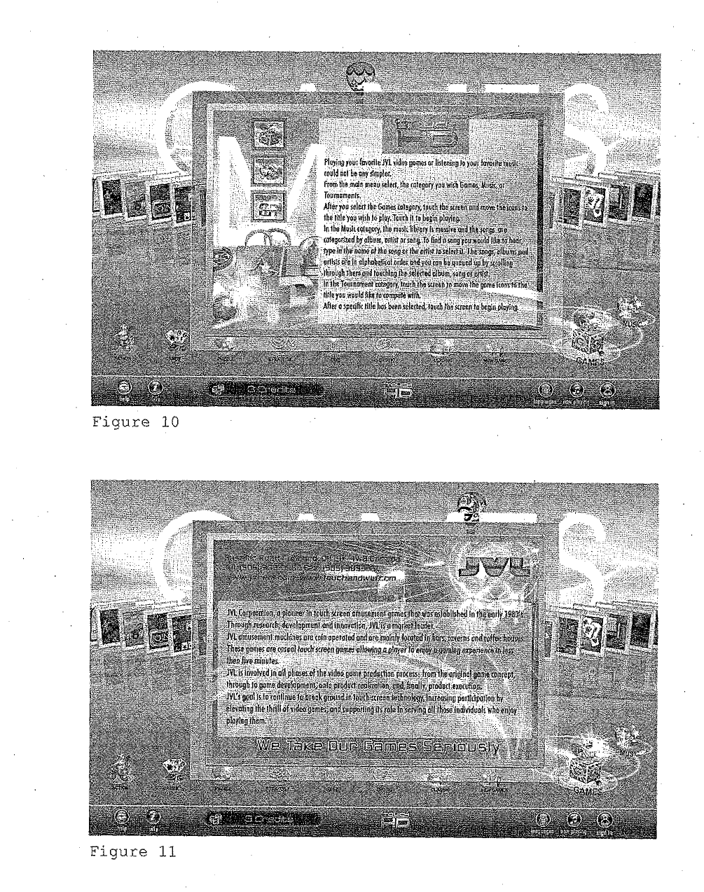

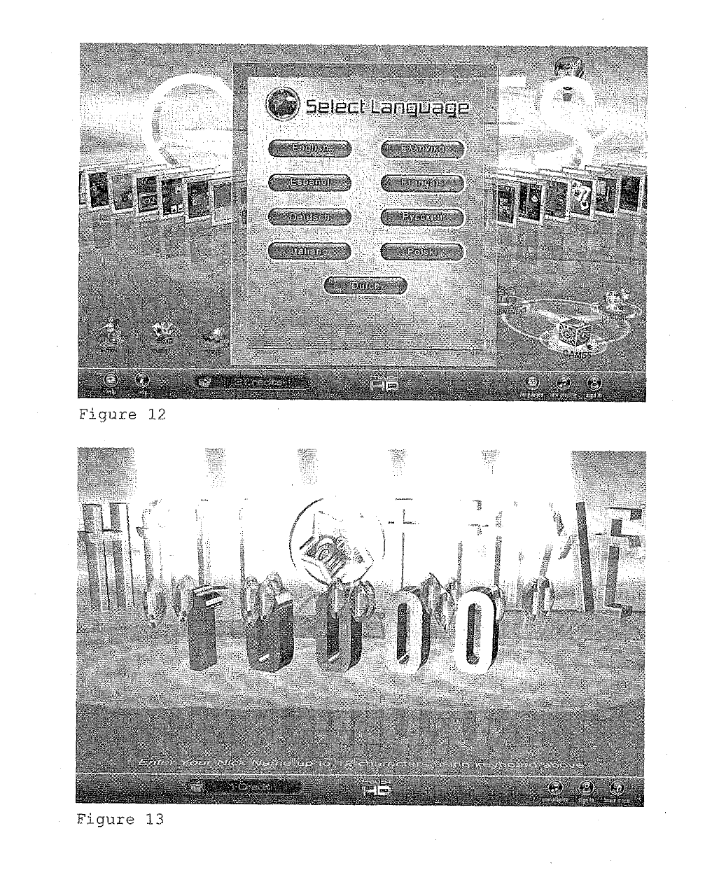

The Help button (51) activates the help screen (FIG. 10). The “INFO” button (52) activates the info screen (FIG. 11). The “LANGUAGE SELECTION” button (53) activates the language selection dialog (FIG. 12). The “SIGN IN” button (54) activates the sign in dialog and the “NOW PLAYING” button (55) activates the screen that shows the currently playing music. The “PLAY” button (50) is used to launch the game currently selected. The play button in FIG. 8 has multiple states: without coins inserted into the system the button simply reads “INSERT COINS” and a description of the number of credits required to play the game. If coins are available the button reads “PLAY” and can actually be used to launch the game. More than a single play button can be present on screen. Some games allow to be played in 2-player mode, in tournament mode or in ICN mode. Also if the setup is set in “FREE PLAY” mode, no coins are required to play the games so the “PLAY” button (50) and the credits indicator (20) will illustrate that. FIG. 9 illustrates the above with a game with more than a single play button while the system is set in “FREE PLAY” mode.

In FIG. 12 the player is given the possibility to choose his preferred language by simply touching the button with the desired language. Once pressed the entire system will use the chosen language for all texts in the system and for all games.

At the completion of the selected game a new screen is presented with the accomplishments of the player in relation to the previous players. This particular screen is called “HALL OF FAME” and a particular image of it is illustrated in FIG. 13.

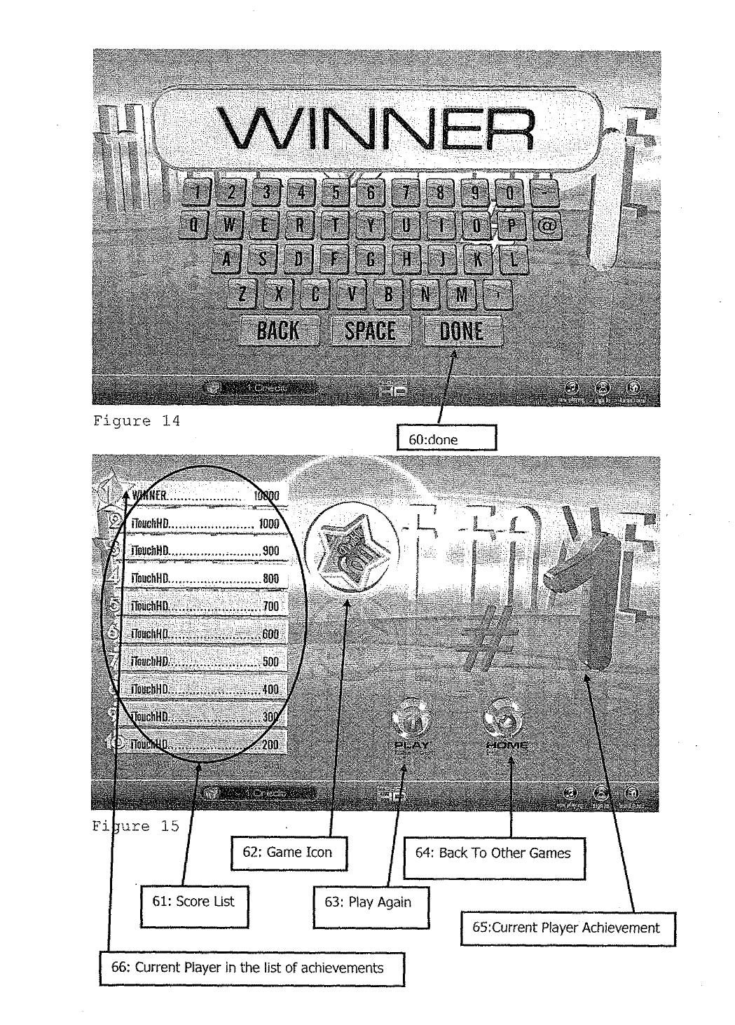

As soon as the hall of frame animation is complete a keyboard is shown on screen to allow the player to enter his identity (nickname). This is illustrated in FIG. 14.

Once the nickname is typed in and the “DONE” button (60) is pressed the screen in FIG. 14 transitions into the screen illustrated in FIG. 15 with the score list (61).

While in the “HALL OF FAME” screen illustrated in FIG. 15, by pressing the “PLAY AGAIN” button (63) the game that was just played can be played again without any delay. This transition is highly optimized because most of the system is already in a state where it knows about the game just played. This particular optimization is of great significance to the player since it offers a very fast way to play the same game several times without waiting. If the player decides to instead play another game he can press the “HOME” button (64), which returns the player to the original game selection screen in FIG. 2.

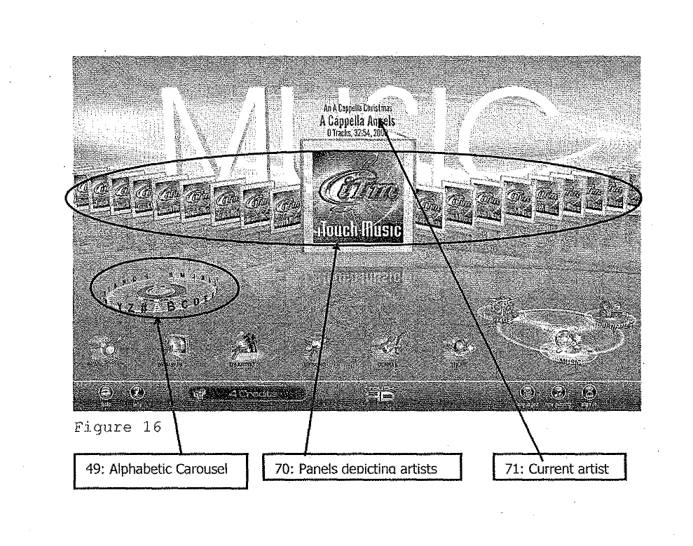

The music screens provide a rich set of methods used to locate the specific song from the millions available in the system database. FIG. 4 presents the songs as part of their album releases FIG. 5 shows an open album and other albums from the same artist. FIG. 6 shows the songs in alphabetical order. FIG. 16 shows the songs grouped by artist.

The alphabetic carousel (49) visible in FIG. 16 can greatly improve the player's ability to select a specific artist by allowing him to jump to a specific alphabetic location in the list of artists. The player does so by dragging the carousel letters until the desired letter reaches the marker in front of the carousel. Then the player clicks the marked letter to confirm his choice.

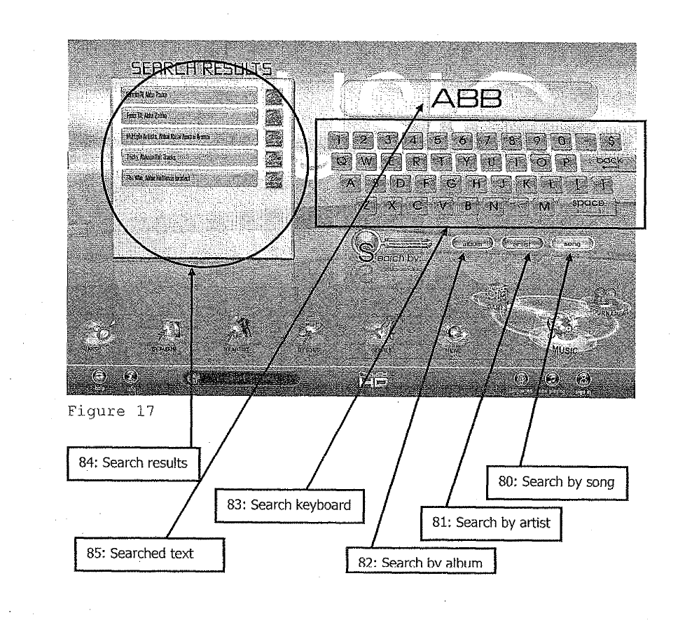

FIG. 17 shows the search screen that allows the player to search the database based on a sequence of characters.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. An entertainment terminal comprising
a computer processor, an operating system, a display screen, a user input arrangement and computer memory;
said terminal including in said computer memory a host of games for play using said terminal;
said terminal further including a user interface displaying on said display screen a subset of said host of games together with user selectable categories, said subset being determined according to a selected or default category displayed on said screen with said subset, said displayed subset allowing a player to review and select a particular game to be played from said subset of games displayed;
said user interface displaying at least a substantial portion of said subset as an adjustable sequence of games extending generally across the display screen with one of said sequence of games according to a predetermined criteria being selectable by a user for play and displayed in increased detail and size, said user interface responding to user input to adjust said sequence whereby any of said sequence of games can be selected by adjustment of said sequence to cause a desired game to be displayed in said increased detail and size;
said user interface displaying on said display screen said categories in an area separate and distinct from said subset;
said user interface upon actuation of one of said categories altering the sequence of games displayed to correspond with said category.

2. An entertainment terminal as claimed in claim 1 wherein said terminal displays said selectable game in a central area of said display screen.

3. An entertainment terminal as claimed in claim 1 wherein said terminal displays said selectable game to partially obscure and overlay adjacent games in said sequence.

4. An entertainment terminal as claimed in claim 3 wherein said sequence of games all include a graphic representation and each game of said sequence other than said selectable game only have a portion of said graphic representation displayed and said selectable game has the complete graphic representation displayed.

5. An entertainment terminal as claimed in claim 4 wherein said sequence of games are displayed as a 3 dimensional image with said selectable game being most forward in the image and the sequence of games either side of said selectable game progressively being more rearward as the separation from said selectable game increases.

6. An entertainment terminal as claimed in claim 5 wherein said categories include graphic representations less than 50% of the size of the graphic represented as of the games of the sequence immediately either side of said selectable game and positioned as a sequence adjacent a lower horizontal edge portion of said display screen.

7. An entertainment terminal as claimed in claim 6 wherein said categories are displayed on said display screen with said sequence of games with the illusion each are supported on a horizontal surface with said categories in the foreground.

8. An entertainment terminal as claimed in claim 7 wherein said interface displays at a bottom horizontal edge of said display screen a strip region of general controls used to clarify operation of said terminal, said display of said general controls not forming part of said horizontal surface.

9. An entertainment terminal as claimed in claim 1 wherein said terminal additionally includes a host of music records that can be selected for play using said terminal, said memory including graphic images of at least albums associated said music records and titles thereof; said user interface providing a user selectable control for selecting between games and music records;
said user interface illustrating an album category of said music records in the same manner as a subset of said games allowing a user to select a particular album, said interface when a particular album is selected providing a larger image in replacement of the selectable album image with said larger image providing details of the music records of said album that can be selected for play.

10. An entertainment terminal as claimed in claim 9 wherein said interface provides details of said music records, said games and said categories on a common three dimensional representation of a horizontal surface extending into said display screen.

11. An entertainment terminal as claimed in claim 10 wherein said display screen is a touch screen and said sequence of games and sequence of music albums are responsive a touch input sweeping across said sequence to vary the sequence as part of the selection process.
